(19) United States
(12) Patent Application Publication
(10) Pub. No.: US 2017/0046784 A1
(43) Pub. Date: Feb. 16, 2017

(54) METHOD FOR PROVIDING INVESTMENT DECISION OPTIONS

(71) Applicant: Agata Marta Kiluk, Wola Zachariaszowska (PL)

(72) Inventor: Agata Marta Kiluk, Wola Zachariaszowska (PL)

(21) Appl. No.: 15/229,335

(22) Filed: Aug. 5, 2016

(30) Foreign Application Priority Data
Aug. 11, 2015 (EP) 15461551.2

(51) Int. Cl. G06Q 40/06; G06F 3/0488; G06F 3/0484; G06F 21/62; G06F 17/30

(52) U.S. Cl. CPC G06Q 40/06; G06F 21/6218; G06F 17/3053; G06F 3/04847; G06F 3/0488

(57) ABSTRACT

A method includes receiving the user decision concerning a portfolio of securities, in particular designation of securities and their portfolio weights in the portfolio, through the user interface; obtaining relevant data from a database of historical securities performance; calculating performance measures for the portfolio structure and displaying them to the user; providing at least one interactively adjustable interface element for enabling the user to control at least one parameter of the portfolio through the user interface wherein, as a result of adjustment of the interface element by the user the user application will update the value of the parameter of the portfolio; apply the updated parameter value to the portfolio; obtain relevant updated data from the database of historical securities performance; and re-calculate updated performance measures for the portfolio; display updated performance measures for the portfolio to the user in an animated form, inducing a motion picture sensation.

### TECHNICAL FIELD

The aspects of the disclosed embodiments are related to a method for providing investment decision options to a user, in a system comprising a first server, a user terminal, and a user application running on the user terminal, wherein the first server has an access to a database of securities historical performance, said database storing information sufficient to identify said securities and time series representing variables describing past securities performance, and said application preferably running on the user terminal is configured to communicate with the user through a graphical user interface and communicate with the first server. The user application is thus able to instantly calculate performance of portfolio asset mix as chosen by the user and present the results to the user. The method can be applied in the e.g. field of investment risk management.

### BACKGROUND

Investment risk caused by unpredictable future variability of assets value can be managed/controlled by aggregation of assets influenced by different risk factors into one portfolio. Independence of fluctuations of large number of impacting risk factors when aggregated in one set results in averaged and reduced variability of portfolio performance measures thus limits investment risk. The portfolio creation process consists of interlacing selection and aggregation phases constituting complex investment decision process. Typically influence of changes of particular asset mix on resulting portfolio performance is complex and hidden from the decision maker, thus unknown or unclear to the decision maker. Thus, for avoiding information overload only limited set of alternatives is presented to the decision maker.

Portfolio performance and particularly risk evaluation requires inclusion of information about interference between fluctuations of all included assets value. Typically statistics such as covariance matrix of assets performance related variables is used to estimate statistics of a dynamic system such as a portfolio. However, use of statistics requires aggregation of the information for all included assets before its use in portfolio performance estimation and thus degrades the quality of the result (e.g. by unrealistic assumptions about the properties of asset value distribution, small number of data samples in time series etc.). Furthermore, because of complex and nonlinear relationship between assets and portfolio performance, the decision process constituted by selection and aggregation of assets is usually performed with methods involving optimization and/or simulation, which seriously limits the possibility for the decision maker to search through large set of alternatives and limits the ability to dynamically change the quality criteria involved in the selection of best alternative (e.g. by predefined quality indicator implemented in optimization).

The main problem to solve is to present a comprehensive set of possible decision options to the investment decision maker in response to series of inquiries induced interactively by the decision maker as reaction to changes of arbitrary chosen decision variable(s) (e.g. portfolio weight(s)), with instantly available portfolio performance measures.

There are two parameters of particular interest to an investor: the return and the risk of a particular portfolio of assets.

The return and the risk of the portfolio are of different relationship to the portfolio weights. The return can be calculated as linear function of returns of the included assets mix (e.g. an arithmetic mean weighted with portfolio weights). The risk of the portfolio is in complex nonlinear relationship to the portfolio weights.

The investor's goal of constructing a portfolio of best performance can be satisfied when the information about relationship between the portfolio composition and portfolio performance in historic period of time (result) is available. Such information covers qualitative aspect of selecting assets and quantitative adjustment of composition of the selected assets portfolio weights. Thus, the user needs conditioning the ability to make investment decision contain the requirement for the following information:
the limits of returns achievable by manipulating asset selection and portfolio weights,
the limits of risk achievable by manipulating asset selection and portfolio weights,
the complex relationship between asset selection and portfolio weights and the resulting portfolio risk,
the influence of second plurality assets portfolio weights on the ability of first asset to change portfolio risk and return.

Because every combination of assets portfolio weights can produce a different portfolio risk and the collection of possible asset portfolio weights is infinite, substantial effort is put into simplifying the decision problem of selecting the asset portfolio weights, wherein the user expectations are typically met by:
limiting infinite number of decision alternatives by selection,
reducing the amount of the information presented to the user by aggregation.

In US 2010 0235299 A1 possible asset set is limited to selected set of asset classes aggregating features of original assets and possible output alternatives are selected by algorithmic generation of perturbed portfolios, including original portfolio and a mix of asset class with preset portfolio weights. Furthermore decision is supported by simultaneous presentation of original portfolio and selected perturbed portfolios for comparison. In another embodiment results of comparison of returns from investments in original and perturbed portfolios are used as input for probabilistic model, reducing the information to the diagnostic signal. Individual asset portfolio weight influence on portfolio risk is shown in form of static graphical representation representing asset class and only for selected portfolio weight values, which greatly reduces the amount of the information but retains the elements important for detecting beneficiary timing and type of changes in the portfolio. On the other hand, the relationship between the presented portfolio performance measures such as return and risk are not referring to the complex interference between variability of returns of all assets in the portfolio due to the generalisation introduced by asset classes and classification. Furthermore, the set of presented alternatives consists of portfolios with algorithmically perturbed mixes, which makes it impossible to gather the knowledge about the influence of particular asset on the performance of portfolio in terms of maximum, minimum, limits of such influence or the shape of the return-risk curve, caused by different portfolio weight values of considered asset due to limitations of claimed static presentation controlled by means of interactively started execution of portfolio perturbation generation and analysis followed by the graphical result presentation. In US 2010 0235299 A1, series of perturbed portfolios are created with use of asset classes [0018] and the model [0019]. Both elements allow for algorithmic selection of a subset of portfolios for further evaluation [0029] and/or presentation [0030], with additional lines linking selected solutions [0031]. In that way all alternatives are presented to the user at once, thus possible to print on the screen or the paper (in a static form), constituting final or intermediate result of the invention.

In another document, US 2006 020531 A1, a solution set is prepared for limited set of asset portfolio weights scenarios and controlled by the user, who adjusts parameter value representing risk-return preference. In case of complex relationship between asset portfolio weights and portfolio return and risk only subset of possible solutions is presented and the omission occurs because multiple input combinations can produce similar results. Thus, the knowledge about relationship between asset portfolio weights and the resulting portfolio return-risk relation remains hidden. The beneficiary effect of US 2006 020531 A1 is achieved by the aggregation of the asset variability into asset classes and selection of the presented results according to efficiency criterion embedded into perturbed portfolio generation algorithm. Again, discovering the influence of assets return variability (risk) and the portfolio risk is impossible for the user (investor, decision maker) or requires additional information on the relationship between considered asset and asset class and further information about selection of presented solutions called portfolio generation.

The European patent EP 1949175 B1 relates to designing of lenses and discloses a decision supporting system which applies complex input-output relationships by means of an instantly interactive system with multiple control variables. In order to scan through exhaustive design alternatives determined with formulas, different adjustment of design parameters of lenses are applied to present the properties of resulting lenses. The relationships between the controlled parameters belong to prior knowledge and have been embedded in the algorithm used in EP 1949175 B1 in order to enable the largest possible set of known solutions rather than to discover unknown relationships between objects of dynamically changing nature. Furthermore, in EP 1949175 B1 all the controlled parameters represent different properties of one object (lens) and are not comparable to each other, e.g. cannot substitute each other or be removed from the resulting object.

It is therefore the objective of the aspects of the disclosed embodiments to propose a new method for providing investment decision options to a user, said method offering advantages over prior art, which will be apparent from the description below, and preferably using client-side technology.

According to the aspects of the disclosed embodiments, to solve the problem of presenting full set of possible decision alternatives regarding assets selection and portfolio weights composition, without prior assumptions on the quality measurement of the resulting solutions, the inventive method interactively provides motion-like representation of relationship between asset portfolio weight and portfolio performance such as return-risk. The user presented such a relationship can memorize it and use any additional criterion for further decision. Those criteria are not built in the method itself and remain in user domain, thus two different users can achieve different outcomes with same method.

Throughout the present patent application, the following terms should be understood as defined below:
Asset, Security—a tradable financial asset e.g. bonds, stocks, futures, options and swaps.
Portfolio weight—the value of the security expressed as the percentage of the value of the whole portfolio containing the security, the portfolio weight is calculated by dividing the value of a security by the total value of the portfolio
Asset mix—The composition of assets in a portfolio with respective portfolio weights
Return—measure of profits on an investment e.g. rate of return, ROI
Risk—measure of investment risk e.g. alpha, beta, r-squared, standard deviation, the Sharpe ratio

### SUMMARY

According to the aspects of the disclosed embodiments, a method for providing investment decision options to a user, in a system comprising a first server, a user terminal and a user application running on the user terminal, wherein the first server has an access to a database of securities historical performance, said database storing information sufficient to identify said securities and time series representing variables describing past securities performance, and said application is configured to communicate with the user through a graphical user interface and is configured to communicate with the first server, said method comprising the following steps executed by the user application:
(i) receiving the user decision concerning a portfolio of securities, in particular designation of securities and their portfolio weights in the portfolio, through the user interface;
(ii) obtaining relevant data from said database of historical securities performance;
(iii) calculating performance measures for the portfolio structure and displaying them to the user;
(iv) providing at least one interactively adjustable interface element for enabling the user to control at least one parameter of the portfolio through the user interface
   is characterized in that, as a result of adjustment of said interface element by the user the user application performs the following steps:
(v) updating the value of said parameter of the portfolio;
(vi) applying the updated parameter value to the portfolio;
(vii) obtaining relevant updated data from said database of historical securities performance;
(viii) re-calculating updated performance measures for the portfolio;
(ix) displaying updated performance measures for the portfolio to the user in an animated form, inducing a motion picture sensation.

Preferably, steps (v)-(ix) are executed instantly after and as the result of adjustment of said interface element by the user, so as to allow to the user to visualize and memorize the relationship between the change in the value of said parameter of the portfolio and the resulting performance measures for the portfolio.

Preferably, said performance measures for the portfolio include any of the following parameters: profit, rate of return, return on assets, return on investment, risk adjusted return, standard deviation, Beta, R-squared, Treynor Measure, Sharpe Ratio, Jensen Measure (known as Alpha).

Preferably, the graphical presentation of assets performance or of portfolio performance to the user is achieved by locating graphical symbols on a two dimensional surface according to assets or portfolio performance, where a first dimension of said surface represents risk of investment and a second dimension orthogonal to the first one represents return on investment.

Preferably, the user interface utilizes a touch screen.

Preferably, said at least one interactively adjustable interface element is selected from the group comprising: a slider, a knob, a scroll, a stepper, a multi-touch gesture, an external motion controller attachable to the user body.

Preferably, there is a first server application running on the first server, said first server application configured for collecting and updating data in the database of historical securities performance.

Preferably, the first server application performs regular updates of the data, with frequency granting accuracy and low latency of the assets performance information.

Preferably, step (ix) comprises any or all of the following actions:
drawing lines connecting points representing estimated performance of assets constituting portfolio with a point representing estimated performance of a portfolio;
labelling the points representing estimated performance of assets constituting portfolio with symbols identifying the assets, preferably with stock tickers;
colouring the linking lines according to the portfolio weight value of the assets in the portfolio.

Preferably, time period is selectable from the graphical user interface by visual elements reacting to user choices of predefined time period durations and delay, and the user application additionally performs any or all of the step of:

recalculation of performance for assets and portfolio in reaction to time period selection;

transition of every point constituting map and representing assets and portfolios performance from the first locations representing a first period of time to the second locations representing a second period of time chosen by the user through the graphical user interface;

transition of lines linking every point representing performance of assets in the portfolio and the portfolio itself from the first location and length for a first period of time to the second location and length for a second period of time chosen by the user through the graphical user interface;

animation of transition of points and lines constituting portfolio graph and map;

presentation of current location and transition of other assets not constituting the portfolio but selected by the user;

Preferably, the user application enables storing the information about asset portfolio of the user in a database and/or retrieving the information about asset portfolio of the user from such a database.

Preferably, the method is carried out in a system additionally comprising a database of pre-registered users, storing information about asset portfolios of these pre-registered users and storing information sufficient to identify said pre-registered users and connections between said pre-registered users and the user, and wherein the user application has access to the database of pre-registered users and is able to provide the user with information about asset portfolios of those of pre-registered users, who are in connection with the user.

Preferably, accessing the information about asset portfolio of a pre-registered user implies execution of a transaction of sharing or trading type.

### BRIEF DESCRIPTION OF THE DRAWINGS

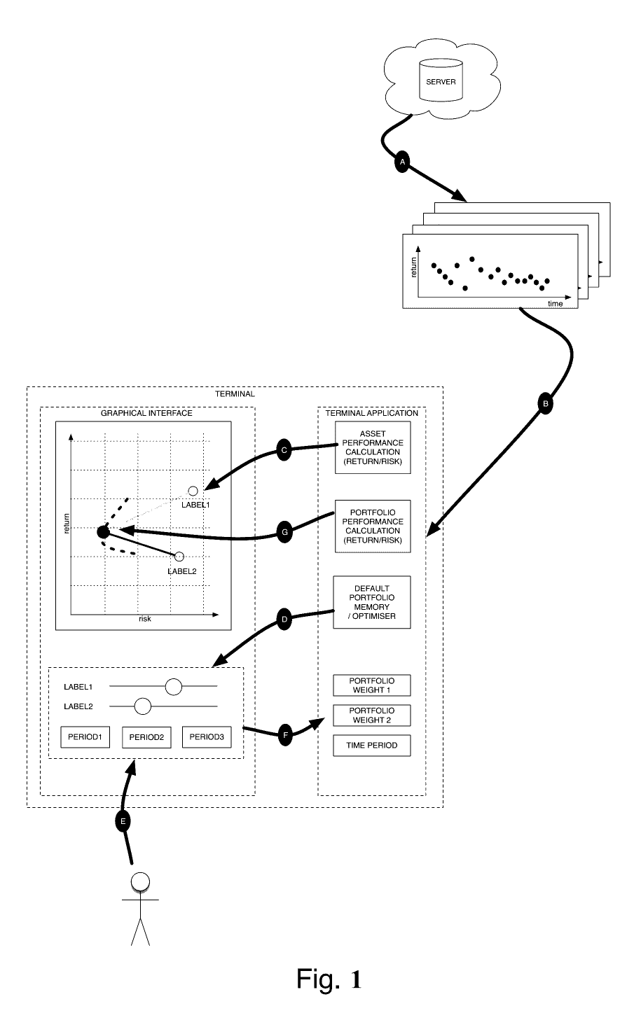

A preferred embodiment of the present invention is described below in a more detailed way with reference to the attached drawing, FIG. 1, which presents architecture of a system and illustrates a scenario of providing investment decision options to a user by a method according to the present invention.

### DETAILED DESCRIPTION

The example below serves only as an illustration and does not limit the scope of the aspects of the disclosed embodiments, as defined in the claims. Required features of the present inventive method are discussed as well as possible options and preferred features are indicated with respect to the embodiment described below.

### EXAMPLE 1

Described below is a method for providing a portfolio performance to a user, in a system comprising a first server, optionally a second server, and necessarily comprising a user terminal, wherein said first server has an access to a database of historical securities performance related time series, stored on a said server. There is a terminal application (called a user application) running on the user terminal, with graphical interface sufficient to gather user decision regarding particular asset portfolio weight represented by the state of interface element adjusted interactively (e.g. by a slider movement) and instantly present performance measures for resulting portfolio structure in animated form, allowing to visualize and memorize the relationship between causing changes in asset portfolio weight and the resulting portfolio performance. In the discussed embodiment, the method comprises the steps of:
collecting time series of values representing historical assets performance (e.g. value, price, daily return);
transferring said time series sets for assets selected by the user from said first server to the user terminal on request invoked by the application on said user terminal;
obtaining the duration of time period used for evaluation of portfolio performance;
calculation of performance measures for every selected asset separately;
generating graphical representation of performance of selected assets;
providing interactive graphical interface elements for manual or semi-verbal expression of user decision about decision variable values (e.g. portfolio weight of particular asset);
resetting the decision variable value (e.g. asset portfolio weight) and corresponding graphical interface elements state according to pre-prepared values;
receiving through the user interface movements of the graphical interface element(s) caused by the interaction from the user and representing expressed decision, translating them into corresponding values representing new asset portfolio weights and storing (memorizing) these values;
calculating values of new time series consisting of values for each point of time in the obtained time period and calculated as average weighted with pre-stored (memorized) asset portfolio weights;
calculating performance measures for the thus constructed portfolio;
redrawing the graphical representation of portfolio performance measures value and presenting it to the user;
   wherein the first server is equipped with an application (a first server application) for collecting and updating the data representing assets performance independently of the user terminal operation. The data is preferably in the form of periodical investment returns with period duration at least an order of magnitude shorter than the available evaluation period and with constant sampling frequency and moments defined uniformly for all time series for all considerable assets. This enables to execute the first server application code in order to sum values from time series for randomly chosen assets and assigned to the same time moment without need for additional processing of data influencing resulting correlations (e.g. resampling, interpolation, stock split rescaling).

Preferably the first server application is performing regular updates of said data with frequency granting low latency and accuracy of the assets performance information.

Preferably the steps from the obtaining the duration of time period used for evaluation of portfolio performance are executed by the user terminal application such as a native application or embedded web code, with benefits of result presentation occurring instantly after user interaction with the graphical user interface. This enables the presentation of sequence of graphical representations of portfolio performance measures values representing series of executions of the aforementioned steps in response to a series of graphical interface element(s) changes invoked by the continuous actions by the user, such as a slider movement, where series of instant application responses to series of registered user actions constitute the psychomotor consciousness of direct relation between the user action representing decision variable change and the movement of graphical element representing portfolio performance.

In one of favorable embodiments of the present inventive method, the graphical presentation of assets performance and the portfolio performance, performed as mentioned in the steps above, is achieved by locating graphical symbols (in particular: points) on a two dimensional surface according to assets or portfolio performance in the selected period, where the first dimension of this surface represents risk of investment and the second dimension, orthogonal to the first one, represents return on investment. More preferably, the scale of the surface with said points and the area currently presented on the screen of the terminal can be adjusted by the user.

More preferably, time duration is selectable from the graphical user interface visual elements reacting to user choices of predefined time period durations and delay, and said user application on the user terminal additionally performs any or all of the steps of:
recalculation of performance for assets and portfolio in reaction to the time period selection;
transition of every point constituting map and representing assets and portfolios performance from the first locations representing the first period of time to the second locations representing the second period of time chosen by the user in interaction through the graphical user interface;
transition of lines linking every point representing performance of assets in the portfolio and the portfolio itself from the first location and length for the first period of time to the second location and length for the second period of time chosen by the user through the graphical user interface;
animation of transition of points and lines constituting the portfolio graph and map;
presentation of current location and transition of other assets not constituting the portfolio but selected by the user.

This procedure enables visual identification of changing influence of assets performance on the performance of the portfolio when different periods of time are considered. Animated transition between evaluation periods allows the user to constantly recognize the position of assets in the portfolio including the end of transition with the graphical representation of the portfolio performance for the second period of evaluation time. Thus additional recognition of graphically presented assets and portfolio performance is not required, reducing greatly cognitive effort to understand changes caused by user actions.

Still more preferably, the graphical user interface utilizes a touch screen technology, or simply: the interface is a touch screen. This provides benefits of perceptual direct link between decision variable value change represented by finger movement and observed changes of the portfolio performance. Repeatable finger movements allow the user to observe and memorize the trace of moving point representing series of performance values thus gathering implicit knowledge about the nature of relation between decision variable value (e.g. asset portfolio weight) and the resulting portfolio performance, which are usually impossible to express or communicate for a user without highly specialized skills and expertise.

Still more preferably, the user application on the user terminal with a touch screen technology additionally performs any or all of the step of:
drawing the lines connecting points representing estimated performance of assets constituting portfolio with a point representing estimated performance of a portfolio;
labeling the points representing estimated performance of assets constituting portfolio with symbols identifying the assets, e.g. stock tickers;
coloring the linking lines according to the portfolio weight value of the asset in the portfolio.

This procedure enables visual recognition of currently decided variable (e.g. asset) without the need for releasing the finger from the touch screen area containing the visual interface element but covered with (hidden under) the finger.

In one of preferred embodiments, the interactive graphical user interface elements for manual or semi-verbal expression of the user decision about value of portfolio weight variables, are assigned separately to each particular decision value, such as each asset portfolio weight, and in form of visual sliders, scrolls or steppers distributed purposefully on the surface of the graphical user interface area to reduce the cognitive effort of the user while changing the decision variable.

In a further preferred embodiment of the inventive method, said pre-prepared values of decision variables can be retrieved from a second server, which second server provides access to a database of registered users, storing information sufficient to identify said registered users and their assigned portfolios. Second server is equipped with an application providing the pre-registered users with the functionality of storing and retrieving portfolios evaluated on a terminal and evaluation of current performance of collected portfolios.

More preferably, said second server is equipped with applications allowing the user terminal application to access the performance of portfolios belonging to users other than user logged into the terminal. The availability of portfolio performance information to other pre-registered users can be decided by the user and communicated to the application on the second server. The availability rules may include re-sharing or trading transactions.

Still more preferably, access to the portfolio belonging to other pre-registered users implies the execution of transaction between the users involved on the said second server of sharing or trading type.

Still more preferably, default assets portfolio weights are memorized and the graphical interface is equipped with visual element (e.g. a switch) invoking changes between default and current decision variable value (e.g. portfolio weights value vector) in response to the user action.

In a preferred embodiment, performance measure annualization for period other than 1 year for easier comparison of performance in periods of different length may be applied to the performance data for easier recognition of tendencies and detection of changes (events) accomplished by reasoning based on comparing results obtained in observation windows of different length.

### EXAMPLE 2

Independent from and in parallel with the description of a favorable embodiment of a method according to the present invention, the description below provides another way of looking at the inventive method.

In brief, the present inventive method comprises the following phases:
PREPARATION PHASE, with the steps of:
   selecting the set of securities considered as possible for inclusion in constructed portfolio;
   collecting daily returns for each of and calculating historical returns and risk for each of the plurality of considerable assets;
   generating with a graphical user interface a two dimensional chart, in which one axis represents risk and another axis represents return;
   generating with a graphical user interface, a first plurality of points representing a risk and return for all considerable assets over the historical period;
   generating with a graphical user interface, a first plurality of active elements assigned to the first plurality of points representing a risk and return for all considerable assets over the historical period;
   optionally generating with the graphical user interface, a first touch active element identifying the range or location of the touch event;
ASSET SELECTION PHASE, with the steps of:
   allowing the user to select assets to include in the portfolio by touching a first plurality of active elements or a location on the map and selecting from the list;
   generating interactive user interface elements such as sliders assigned to previously selected assets with initial portfolio weights value;
SLIDERS CHANGE TRIGGERED SEQUENCE, with the steps of:
   gathering changes of portfolio weights from interactive user interface elements (such as sliders);
   creating portfolio daily returns for registered assets portfolio weights;
   calculating historical returns and risk for the portfolio;
   generating with the graphical user interface, a second point representing a risk and return for the constructed portfolio;
   generating with the graphical user interface, a plurality of first lines linking the first plurality of points representing a risk and return for all selected assets over the historical period with a second point representing a risk and return for the portfolio;
HISTORICAL PERIOD CHANGE SEQUENCE, with the steps of:
   generating with the graphical user interface an animated sequence representing the transition of the first plurality of points, the second portfolio point and the first plurality of lines from the previously selected historical period representing a risk and return for the selected assets and portfolio over the first historical period to positions representing the risk and return for selected assets and portfolio over the second historical period;

In the present invention, the results are not presented to the user as a set of points or other elements visible simultaneously in a static manner, but rather are presented as a sequence of results inducing motion picture sensation. This is considered a major advantage of the invention, because it allows the user to visualize and memorize the relationship between causing changes in asset portfolio weights and the resulting portfolio performance.

1. A method for providing investment decision options to a user, in a system comprising a first server, a user terminal and a user application running on the user terminal, wherein the first server has an access to a database of securities historical performance, said database storing information sufficient to identify said securities and time series representing variables describing past securities performance, and said application is configured to communicate with the user through a graphical user interface and is configured to communicate with the first server, said method comprising the following steps executed by the user application:
(i) receiving the user decision concerning a portfolio of securities, in particular designation of securities and their portfolio weights in the portfolio, through the user interface;
(ii) obtaining relevant data from said database of historical securities performance;
(iii) calculating performance measures for the portfolio structure and displaying them to the user;
(iv) providing at least one interactively adjustable interface element for enabling the user to control at least one parameter of the portfolio through the user interface
wherein
as a result of adjustment of said interface element by the user the user application performs the following steps:
(v) updating the value of said parameter of the portfolio;
(vi) applying the updated parameter value to the portfolio;
(vii) obtaining relevant updated data from said database of historical securities performance;
(viii) re-calculating updated performance measures for the portfolio;
(ix) displaying updated performance measures for the portfolio to the user in an animated form, inducing a motion picture sensation.

2. The method according to claim 1, wherein steps (v)-(ix) are executed instantly after and as the result of adjustment of said interface element by the user, so as to allow to the user to visualize and memorize the relationship between the change in the value of said parameter of the portfolio and the resulting performance measures for the portfolio.

3. The method according to claim 1, wherein said performance measures for the portfolio include any of the following parameters: profit, rate of return, return on assets, return on investment, risk adjusted return, standard deviation, Beta, R-squared, Treynor Measure, Sharpe Ratio, Jensen Measure (known as Alpha).

4. The method according to claim 1, wherein the graphical presentation of assets performance or of portfolio performance to the user is achieved by locating graphical symbols on a two dimensional surface according to assets or portfolio performance, where a first dimension of said surface represents risk of investment and a second dimension orthogonal to the first one represents return on investment.

5. The method according to claim 1, wherein the user interface utilizes a touch screen.

6. The method according to claim 5, wherein said at least one interactively adjustable interface element is selected from the group comprising: a slider, a knob, a scroll, a stepper, a multi-touch gesture, an external motion controller attachable to the user body.

7. The method according to claim 1, wherein there is a first server application running on the first server, said first server application configured for collecting and updating data in the database of historical securities performance.

8. The method according to claim 7, wherein the first server application performs regular updates of the data, with frequency granting accuracy and low latency of the assets performance information.

9. The method according to claim 1, wherein step (ix) comprises any or all of the following actions:
drawing lines connecting points representing estimated performance of assets constituting portfolio with a point representing estimated performance of a portfolio;
labelling the points representing estimated performance of assets constituting portfolio with symbols identifying the assets, preferably with stock tickers;
colouring the linking lines according to the portfolio weight value of the assets in the portfolio.

10. The method according to claim 1, wherein time period is selectable from the graphical user interface by visual elements reacting to user choices of predefined time period durations and delay, and the user application additionally performs any or all of the step of:
recalculation of performance for assets and portfolio in reaction to time period selection;
transition of every point constituting map and representing assets and portfolios performance from the first locations representing a first period of time to the second locations representing a second period of time chosen by the user through the graphical user interface;
transition of lines linking every point representing performance of assets in the portfolio and the portfolio itself from the first location and length for a first period of time to the second location and length for a second period of time chosen by the user through the graphical user interface;
animation of transition of points and lines constituting portfolio graph and map;
presentation of current location and transition of other assets not constituting the portfolio but selected by the user;

11. The method according to claim 1, wherein the user application enables storing the information about asset portfolio of the user in a database and/or retrieving the information about asset portfolio of the user from such a database.

12. The method according to claim 1, wherein the method is carried out in a system additionally comprising a database of pre-registered users, storing information about asset portfolios of these pre-registered users and storing information sufficient to identify said pre-registered users and connections between said pre-registered users and the user, and wherein the user application has access to the database of pre-registered users and is able to provide the user with information about asset portfolios of those of pre-registered users, who are in connection with the user.

13. The method according claim 12, wherein accessing the information about asset portfolio of a pre-registered user implies execution of a transaction of sharing or trading type.
